(19) United States
(12) Patent Application Publication
(10) Pub. No.: US 2016/0147536 A1
(43) Pub. Date: May 26, 2016

(54) Transitioning the Processor Core from Thread to Lane Mode and Enabling Data Transfer Between the Two Modes

(71) Applicant: International Business Machines Corporation, Armonk, NY (US)

(72) Inventors: David J. Edelsohn, White Plains, NY (US); Jose E. Moreira, Irvington, NY (US); Mauricio J. Serrano, Bronx, NY (US); Ilie G. Tanase, Somers, NY (US); Jessica H. Tseng, Fremont, CA (US); Peng Wu, Rochester, NY (US)

(21) Appl. No.: 14/552,145

(22) Filed: Nov. 24, 2014

(51) Int. Cl. G06F 9/30

(52) U.S. Cl. CPC G06F 9/30189; G06F 9/3009; G06F 9/30123

(57) ABSTRACT

Techniques for switching between two (thread and lane) modes of execution in a dual execution mode processor are provided. In one aspect, a method for executing a single instruction stream having alternating serial regions and parallel regions in a same processor is provided. The method includes the steps of: creating a processor architecture having, for each architected thread of the single instruction stream, one set of thread registers, and N sets of lane registers across N lanes; executing instructions in the serial regions of the single instruction stream in a thread mode against the thread registers; executing instructions in the parallel regions of the single instruction stream in a lane mode against the lane registers; and transitioning execution of the single instruction stream from the thread mode to the lane mode or from the lane mode to the thread mode.

### FIELD OF THE INVENTION

The present invention relates to a dual execution mode processor, and more particularly, to techniques for switching between two (thread and lane) modes of execution.

### BACKGROUND OF THE INVENTION

Typical parallel programs consist of alternating serial/parallel regions. Existing approaches to running parallel programs rely on a “discontinuity” of the instruction stream. For example, the execution goes from single-threaded to multi-threaded in conventional CPUs, and from main CPU to separate accelerator in CPU+GPUs. There are notable limitations to this approach such as overhead of discontinuity, large granularity of the regions, and necessity of “communication” (even with shared memory) between regions.

Therefore improved techniques for executing parallel programs and for switching between serial and parallel regions would be desirable.

### SUMMARY OF THE INVENTION

The present invention provides techniques for switching between two (thread and lane) modes of execution in a dual execution mode processor. In one aspect of the invention, a method for executing a single instruction stream having alternating serial regions and parallel regions in a same processor is provided. The method includes the steps of: creating a processor architecture having, for each architected thread of the single instruction stream, one set of thread registers, and N sets of lane registers across N lanes; executing instructions in the serial regions of the single instruction stream in a thread mode against the thread registers; executing instructions in the parallel regions of the single instruction stream in a lane mode against the lane registers; and transitioning execution of the single instruction stream from the thread mode to the lane mode or from the lane mode to the thread mode.

A more complete understanding of the present invention, as well as further features and advantages of the present invention, will be obtained by reference to the following detailed description and drawings.

### BRIEF DESCRIPTION OF THE DRAWINGS

FIG. 1 is a schematic diagram illustrating an exemplary instruction stream having both serial and parallel regions according to an embodiment of the present invention;

FIG. 2 is a diagram illustrating an exemplary methodology for dual execution (in thread and lane modes) of a single stream of instructions in the same processor according to an embodiment of the present invention;

FIG. 3 is a diagram illustrating an example of a set of thread registers against which instructions in serial regions of the instruction stream can be executed in thread mode according to an embodiment of the present invention;

FIG. 4 is a diagram illustrating an example of a set of lane registers against which instructions in parallel regions of the instruction stream can be executed in lane mode according to an embodiment of the present invention;

FIG. 5 is a diagram illustrating an exemplary methodology for executing a single instruction stream having alternating serial and parallel regions in the same processor according to an embodiment of the present invention;

FIG. 6 is a diagram illustrating an exemplary methodology for transitioning from thread mode to lane mode and from lane mode to thread mode according to an embodiment of the present invention;

FIG. 7 is a diagram illustrating an exemplary methodology for switching from thread mode to lane mode according to an embodiment of the present invention;

FIG. 8A is a diagram illustrating an exemplary methodology for voluntarily switching (transitioning) the processor core from lane mode to thread mode according to an embodiment of the present invention;

FIG. 8B is a diagram illustrating an exemplary methodology for involuntarily switching (transitioning) the processor core from lane mode to thread mode according to an embodiment of the present invention; and

FIG. 9 is a diagram illustrating an exemplary apparatus for performing one or more of the methodologies presented herein according to an embodiment of the present invention.

### DETAILED DESCRIPTION OF PREFERRED EMBODIMENTS

Provided herein are techniques for implementing dual execution (thread and lane) modes in the same processor executing a single stream of instructions (using a unified processor instruction set architecture instruction stream that can alternate between serial and parallel regions). Thus accordingly herein, one processor executes one stream of instructions but operates in two modes, and what the instruction does depends on the mode. Specifically, the present techniques accomplish vectorization in space by replicating the same instruction across multiple (architected) lanes, with a different set of registers for each lane. At any given time, a lane can be in one of two states: enabled or disabled. Enabled lanes perform operations. Disabled lanes do not perform operations. It is noted that the terms “enabled” and “disabled,” as used herein, refer to the architected lanes. Techniques are then provided herein for switching between the two modes of execution.

Use of a unified processor instruction stream that can alternate between serial and parallel regions results in a very cheap transition between regions and region-to-region data exchange, and therefore regions can be as small as a single instruction. Use of the present techniques leads to efficient execution of the parallel regions of a program. In particular, programs that run well on the old models (multiple CPUs, CPU+GPUs) also run well here. Furthermore, there are other programs that do not run efficiently in the older modes but run well in accordance with the present techniques.

As will be described in detail below, the present techniques involve executing an instruction stream that consists of alternating serial and parallel regions. By way of example only, FIG. 1 depicts schematically an exemplary instruction stream 100 having both serial and parallel regions. For instance, the instruction stream 100 begins with a serial region consisting of a single thread (ST). A fork instruction institutes forking of the thread into a parallel region consisting of multiple lanes (multi-lanes). A join instruction joins/rejoins the multi-lanes back into a single thread in a second serial region of the instruction stream 100, and so on. As shown in FIG. 1, these serial and parallel regions alternate within the instruction stream 100.

According to the present techniques, the instructions in the serial regions of the instruction stream 100 are executed in what is termed herein as “thread mode,” and the instructions in the parallel regions of the instruction stream 100 are executed in what is termed herein as “lane mode.” Specifically, provided herein is a unique processor architecture which includes, for each architected thread of instructions, one set of thread registers and N sets of lane registers. Accordingly, the instructions in the serial regions of the instruction stream 100 are executed in thread mode against the thread registers. The instructions in the parallel regions of the instruction stream 100 are executed in lane mode against the lane registers. The thread and lane registers will be described in detail below.

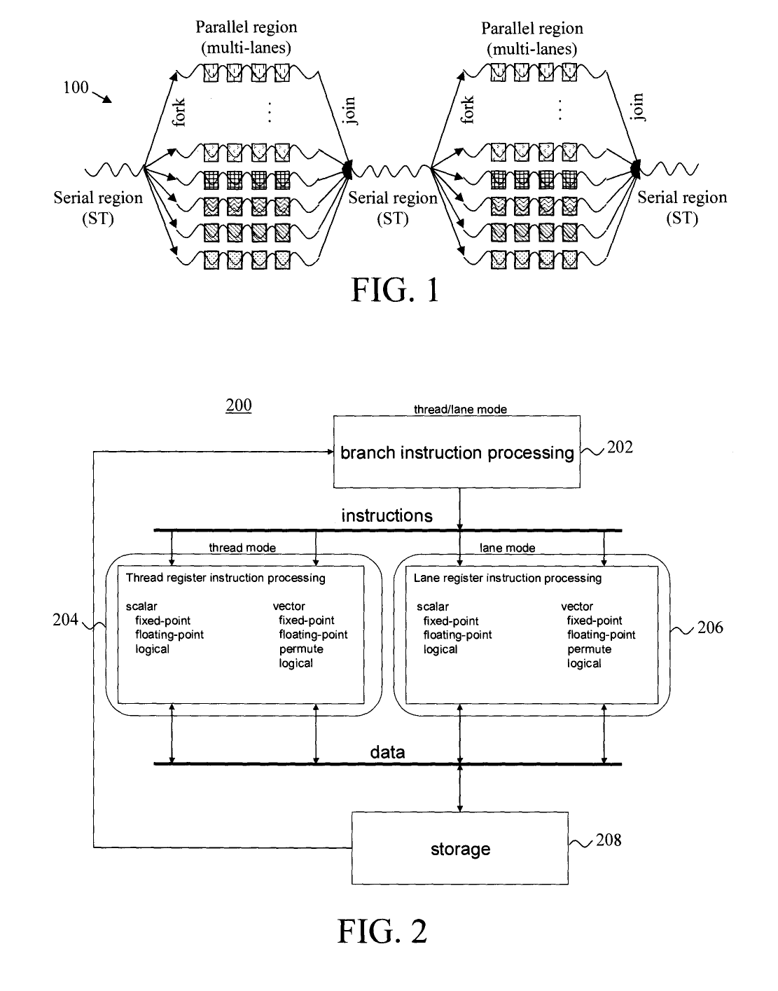

Methodology 200 of FIG. 2 provides an overview of the present techniques for dual execution (thread and lane) modes in the same processor executing a single stream of instructions. As highlighted above, the instruction stream consists of alternating serial and parallel regions (and thus according to the present techniques the instruction stream can be in one of two modes, thread mode or lane mode, respectively), and the processor contains—for each architected thread of instructions—one set of thread registers and N sets of lane registers.

The processor executes a single stream of instructions. As shown in step 202 of FIG. 2, branch instructions control the stream evolution. As will be described in detail below, by default the instructions will be executed from consecutive memory address locations. Only branch instructions can change that flow. According to one exemplary embodiment, branches are always executed against thread registers.

Serial regions of the instruction stream 100 are processed, as per step 204, in thread mode using the thread registers, while parallel regions of the instruction stream 100 are processed, as per step 206, in lane mode using the lane registers. As shown in FIG. 2, the present techniques generally support both scalar (e.g., fixed-point, floating-point, logical, etc.) and vector (fixed-point, floating-point, permute, logical, etc.) operations in the thread and lane registers. Scalar and vector processing of data in registers is generally known to those of skill in the art and thus is not described further herein.

In step 208, the manipulated data is stored in memory (storage), and the process is repeated beginning at step 202 with the next branch instruction. As shown in FIG. 2, data moves back and forth between the registers and storage. For example, data is fetched from the storage and loaded into the (thread and/or lane) registers where it is manipulated by the instruction stream. The manipulated data can then be stored back in memory.

A more detailed description of the thread and lane registers is now provided. As described above, each architected thread in the processor has one set of thread registers. According to an exemplary embodiment, the set of thread registers contains at least one of the following component registers: general purpose registers (GPR), floating point registers (FPR), vector registers (VR), status registers (SR), condition registers (CR), and auxiliary registers (AR). As provided above, the present techniques involve a single processor executing a single stream of instructions, wherein the processor can operate in either thread or lane mode. When operating in thread mode, the instruction stream will be executed by the processor against this set of thread registers.

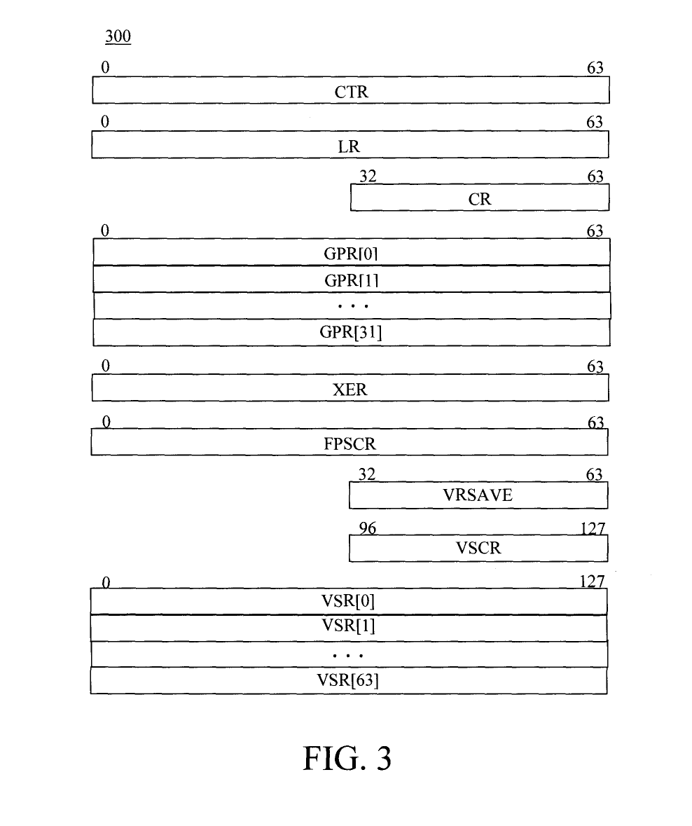

FIG. 3 provides an example of a set 300 of thread registers that could be implemented in accordance with the present techniques. Of course, the particular thread (and lane) registers can vary for a given application. Thus the set of thread registers shown in FIG. 3 is merely an example meant to illustrate the present techniques. What is important to note is that there is one set of thread registers for each architected thread of instructions (as compared to N sets of lane registers—see below). Thus, what the architected thread of instructions does depends on whether it is being executed in thread or lane mode, against the thread or lane registers, respectively.

As shown in FIG. 3, in this particular non-limiting example the thread registers include at least one count register (CTR), at least one link register (LR), at least one condition register (CR), multiple general purpose registers (GPR, e.g., GPR[0]-[31]), at least one XER register, at least one floating-point status and control register (FPSCR), at least one vector status and control register (VSCR), at least one vector save/restore register (VRSAVE), and multiple vector-scalar registers (VSR, e.g., VSR[0]-[63]). In thread mode, instructions in the instruction stream are dispatched once and operations are performed (serially) one instruction at a time.

By contrast, each architected thread in the processor has N sets of lane registers. According to an exemplary embodiment, each set of lane registers contains at least one of the following component registers: general purpose registers (GPR), floating point registers (FPR), vector registers (VR), status registers (SR), condition registers (CR), and auxiliary registers (AR). As provided above, the present techniques involve a single processor executing a single stream of instructions, wherein the processor can operate in either thread or lane mode. When operating in lane mode, the instruction stream will be executed by the processor against each set of lane registers.

In one exemplary embodiment, the thread registers contain the same combination of component registers as at least one set of the lane registers. Alternatively, according to another exemplary embodiment, the thread registers contain a different combination of component registers from one or more sets of the lane registers. When the components of the set of thread registers are the same as the components of one set of the lane registers, there is a one-to-one correspondence between thread registers and lane registers. In this case, the semantics of an instruction in lane mode can be obtained from the semantics of the instruction in thread mode by substituting the corresponding lane register for the corresponding thread register. When the components of the set of thread registers are different from the components of one set of the lane registers, the correspondence between them is not exactly one-to-one. That requires different definitions for the semantics of instructions in thread and lane mode.

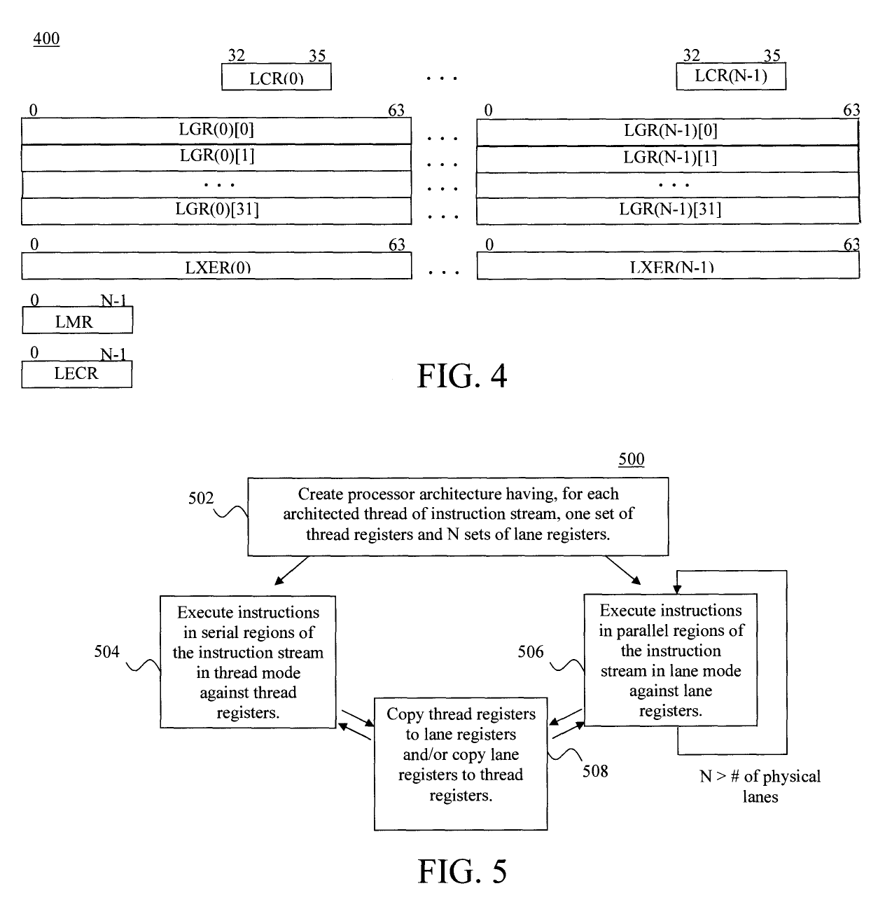

FIG. 4 provides an example of N sets 400 of lane registers that could be implemented in accordance with the present techniques. Again, the particular thread (and lane) registers can vary for a given application. Thus the sets of lane registers shown in FIG. 4 are merely an example meant to illustrate the present techniques. What is important to note is that there are N sets of lane registers for each architected thread of instructions (as compared to one set of thread registers). Thus, what the architected thread of instructions does depends on whether it is being executed in thread or lane mode, against the thread or lane registers, respectively.

As shown in FIG. 4, in this particular non-limiting example each set of lane registers includes at least one lane condition register (LCR), multiple lane general purpose registers (LGR, e.g., LGR[0]-[31]), and at least one lane XER register (LXER). As with the thread register example above, not all of these register types are necessary. The N sets of lane registers are labeled (0)-(N−1) in FIG. 4.

In one exemplary embodiment, the same combination of lane registers is present in each set. In that case, each architected thread in the processor has N identical sets of lane registers. However, single-instance auxiliary registers may also be part of the architected state. For example, as shown in FIG. 4 a single-instance auxiliary lane move register (LMR) and lane extended control register (LECR) are present.

A transition from thread mode to lane mode entails performing the same operation but repeated multiple times, one for each (architected) lane in the processor. For the execution of an instruction in lane mode the processor can be designed with multiple physical lanes, e.g., multiple hardware resources to support simultaneous execution of the instructions. Thus, transitioning from thread mode to lane mode the processor goes from performing one operation (serially) per instruction against one register set at a time—see above—to performing the same operation multiple times per instruction (in parallel) against multiple sets of registers on multiple (architected) lanes. Thus, in lane mode, operations are performed across multiple lanes. A distinction is made herein between physical lanes in the processor and architected lanes. For instance, as known in the art a multi-lane vector processor has multiple physical lanes which enable parallel data processing. Architected lanes, on the other hand, are virtual lanes constructed to run on the physical lanes of the processor. The number of physical lanes is decided based on hardware constraints like area, power consumption, etc. Each physical lane is a hardware unit capable of executing the operation defined by an instruction. When a processor has multiple physical lanes, they can execute in parallel, with multiple operations performed at the same time. Architected lanes are a construct to provide virtualization. Multiple architected lanes can be multiplexed on top of the existing physical lanes. This virtualization is implemented at the hardware level—each instruction generates multiple operations. Let a processor have N architected lanes and L physical lanes. In the case of one-to-one mapping of architected to physical lanes (L=N), the processor will operate as follows:

1 fetch an instruction at PC
2 dispatch the instructions to all N lanes
3 Each physical lane i will set logical identity i and execute the instruction using register set R_i (the register set of lane i)
4 PC=next PC
5 go to 1
With multiple architected lanes mapped to each physical lane, the processor behaves differently. First, there will be N=K*L architected lanes, L is the number of physical lanes, and K is a multiplier. Now the processor will execute instruction like this:
1 fetch an instruction at PC
2 for round=0; round<ceil(K); ++round
3 Dispatch the instruction to all L lanes
4 Each physical lane i will set logical identity i*round and execute the instruction using register set R_(i*round) (if i*round <N)—this is the register set of architected lane i*round
5 endfor
6 PC=next PC
7 go to 1
The term “set logical identity x” means that the physical lane will behave as architected lane “x”; this identity is often used inside instructions executed in lane mode. Thus, creating architected lanes is adding some additional logic on the processor to dispatch an instruction multiple times to a physical lane after properly setting an identity register and to support routing to the correct set of registers. The above description of the behavior of a processor does not restrict the possibility of overlapping instruction execution. For example, in a processor with 2 physical lanes (P1, P2) and 3 architected lanes (A1, A2, A3), it is possible to overlap the execution of 2 instructions on 3 architected lanes so that they execute in 3 iterations: Iteration 1 executes instruction 1 in architected lanes A1, A2; Iteration 2 executes instruction 1 in architected lane A3 and instruction 2 in architected lane A1; Iteration 3 executes instruction 2 in architected lanes A2, A3.

Thus, in accordance with the present techniques, if for example in lane mode there are 8 sets of lane registers (N=8) and thus 8 architected lanes, then in order to process the instruction stream in lane mode with a processor having 4 physical lanes the process will have to be repeated multiple times. To give a simple example, at least two iterations of the process would be required to process the instruction stream in lane mode across 8 architected lanes for a processor having 4 physical lanes. Assuming all 4 (physical) lanes are being used, then exactly two iterations would be required. However, it may be the case that only a portion of the processor is devoted to the present computation, thus requiring more iterations. For instance, if two (physical) lanes of the processor are devoted to the computation then four iterations would be needed to process the instruction stream in lane mode across 8 architected lanes.

Branch instructions control the evolution of the instruction stream. Namely, the default condition is to execute the instruction at the next sequential memory address. Only branch instructions can change that flow. According to the present techniques, branches always have the same semantics, independent of thread/lane mode. Conditional branches always test a thread condition register. In one exemplary embodiment, branches to an address contained in a register always use a thread register. As will be described in detail below, execution preferably begins in thread mode and explicit instructions are used to transition from thread to lane mode.

As described generally above, data moves back and forth between the registers and storage. For example, data is fetched from the storage and loaded into the (thread and/or lane) registers where it is manipulated by the instruction stream. The manipulated data can then be stored back in memory. See description of FIG. 2 above. As is known in the art, storage access instructions in the instruction stream such as those directed to load and store operations are used in this regard to direct accessing the data from memory and to storing the results back to memory, respectively.

According to an exemplary embodiment of the present techniques, these storage access instructions are (thread or lane) mode dependent. For example, in this instance—when the stream of instructions is being executed in thread mode, the load and store operations are always applied to the thread registers. The thread registers are thus used as the data source, the data target, and the address source. As provided above, in thread mode operations are performed (serially) one at a time. Thus, each load/store operation is executed unconditionally in thread mode and causes one memory operation.

By contrast, when the instructions are being executed in lane mode, the load and store operations are always applied to lane registers. Accordingly, the lane registers are used as the data source, the data target, and the address source. In lane mode operations are performed (in parallel) on N (architected) lanes. Thus, each load/store operation is executed once per lane, with up to N memory operations/instructions. However, as highlighted above, operations in lane mode are conditional on the state (enabled/disabled) of each (architected) lane. For instance, when performing load/store operations in lane mode across multiple lanes, only those lanes that are enabled can be used. Thus, load/store execution in lane mode is contingent upon whether a given lane is enabled or not.

Similarly, according to an exemplary embodiment of the present techniques, arithmetic and logic instructions are also (thread or lane) mode dependent. For example, in this instance—when the stream of instructions is being executed in thread mode, arithmetic and logic instructions are always applied to thread registers. The thread registers are thus used as the data source and the data target. As provided above, in thread mode operations are performed (serially) one at a time. Thus, each arithmetic/logic instruction is executed unconditionally in thread mode and causes one operation.

By contrast, when the instructions are being executed in lane mode, the arithmetic and logic instructions are always applied to lane registers. Accordingly, the lane registers are used as the data source and the data target. In lane mode, operations are performed (in parallel) on N (architected) lanes. Thus, each arithmetic/logic instruction is executed once per lane, with up to N operations/instructions. However, as highlighted above, operations in lane mode are conditional on the state (enabled/disabled) of each lane. For instance, when executing arithmetic/logic instructions in lane mode across multiple lanes, only those lanes that are enabled can be used. Thus, arithmetic/logic instruction execution in lane mode is contingent upon whether a given lane is enabled or not.

It is notable that when operating in lane mode, according to one exemplary embodiment of the present techniques the instructions are executed in lockstep across all of the lanes. Namely, the (same) instruction which is dispatched to each of the lanes is executed at the same time, in parallel across each of the lanes. Alternatively, according to another exemplary embodiment of the present techniques the instructions dispatched in lane mode are executed asynchronously (i.e., not at the same time) across the lanes. By way of example only, execution of instructions at one or more of the lanes might be contingent upon completion of an operation at one or more other of the lanes.

Independent of the way instructions are executed, instruction execution can follow global program order or local program order. With global program order, the effects of all previous dependent instructions on all of the lanes are visible to the current executing instruction in each lane. With local program order, only the effects of previous dependent instructions on the same lane are guaranteed to be visible in each lane.

Transitioning between thread and lane mode execution will be described in detail below. In general, however, bridge instructions inserted within the instruction stream can be used to explicitly control the execution mode of the stream. Namely, bridge instructions can encode when serial regions or parallel regions of the instruction stream exist and should thus be executed in thread or lane mode, respectively. According to an exemplary embodiment, bridge instructions in the instruction stream can be executed and have the same semantics in either (thread or lane) mode. The transitioning from thread mode to lane mode, and vice versa, can involve copying thread registers to lane registers and vice versa.

FIG. 5 is a diagram illustrating an exemplary methodology 500 for executing a single instruction stream having alternating serial and parallel regions in the same processor. In step 502, a processor architecture is created having, for each architected thread of the instruction stream, one set of thread registers and N sets of lane registers. Exemplary thread mode component registers and lane mode component registers were described in detail above. See also the exemplary set 300 of thread registers shown in FIG. 3 and the exemplary N sets 400 of lane registers shown in FIG. 4.

In step 504, instructions in the serial regions of the instruction stream are executed in thread mode against the thread registers. Thread mode execution can involve dispatching the thread mode instructions once to the thread registers. As provided above, in thread mode instructions are preferably always applied to the thread registers and each instruction is executed unconditionally and causes one operation.

In step 506, instructions in the parallel regions of the instruction stream are executed in lane mode against the lane registers. Lane mode execution can involve dispatching the same instruction multiple times, i.e., dispatching the lane mode instructions N times, once for each of the N lanes. As provided above, in lane mode instructions are preferably always applied to the lane registers and each instruction is executed once per lane, with up to N operations/instructions. Execution of lane mode instructions is however contingent upon the state of the lane (enabled/disabled). Thus, as shown in FIG. 5, when the number of architected lanes N exceeds the number of physical lanes for lane mode execution, then multiple iterations are needed to perform the lane mode operations.

As provided above, transitioning execution of the instruction stream from thread mode to lane mode, or vice versa can include copying the thread registers to the lane registers or vice versa. This can be performed in step 508 in response to a bridge instruction encoded in the instruction stream signifying a transition from a serial region to a parallel region of the stream, or vice versa.

Given the above description of dual (thread and lane) execution modes for an instruction stream, techniques are now provided for transitioning the processor core from thread to lane mode (and vice versa) and for enabling data transfer between the two modes. As provided above, in thread mode there is one set of registers and in lane mode there are multiple sets of registers (one set per lane). There is however only a single set of instructions. Thus the challenge becomes how to transition from having one set of registers to having one set of registers per lane. Provided below are techniques for instructing the processor that following a thread-to-lane/lane-to-thread mode transition the instruction has a different meaning.

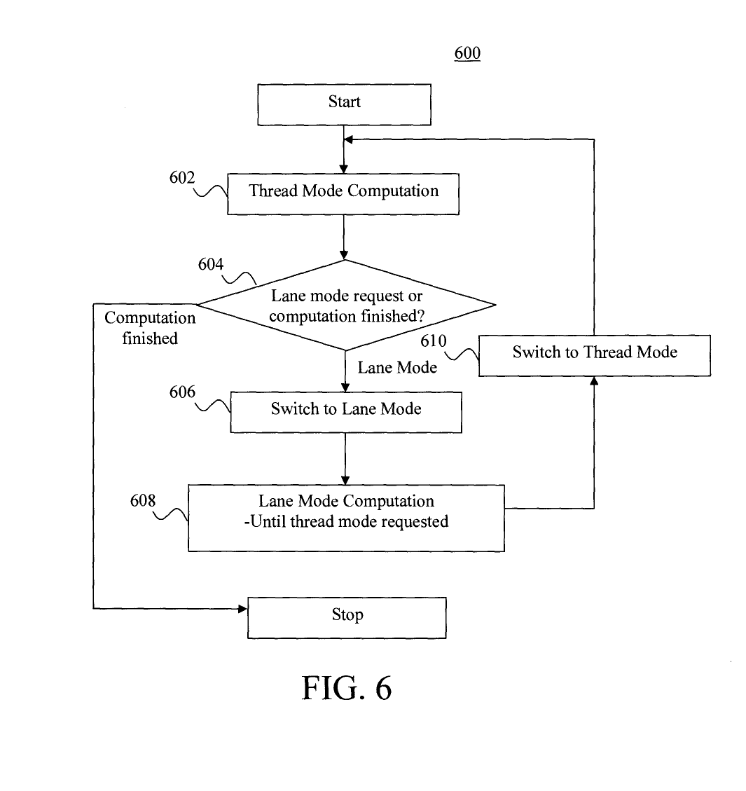

In general, these thread-to-lane/lane-to-thread mode transitioning techniques involve the following actions: prepare and transfer the necessary state from thread to lane resources, change the processor to lane mode, execute multi-lane computation, prepare and transfer the necessary state from lane to thread resources, and change the processor to thread mode. A detailed description of the present thread-to-lane/lane-to-thread mode transitioning techniques is now provided by way of reference to methodology 600 of FIG. 6.

According to an exemplary embodiment, execution of the instruction stream starts out in thread mode. See step 602. Thread mode execution will continue until, as per step 604, either a request is made to transition into lane mode execution (i.e., a lane mode request) or the computation is finished. If the computation is finished, then the process is ended.

On the other hand, if a lane mode request is encountered, then in step 606 a transition is made from thread to lane mode. As provided above, bridge instructions encoded in the instruction stream can signify when serial regions or parallel regions of the instruction stream exist and should thus be executed in thread or lane mode, respectively. Thus the transition from thread to lane mode, or vice versa can be in response to a bridge instruction encoded in the instruction stream.

According to the present techniques, the initiation of a transition from thread mode to lane mode is a fairly straightforward process. Namely, the thread-to-lane mode transition occurs (voluntarily) based on encountering an explicit instruction such as a lane mode request. By comparison, as will be described in detail below, transitioning from lane mode to thread mode however can occur either voluntarily (i.e., in response to encountering an explicit instruction such as a thread mode request) or involuntarily when an exception occurs during one of the instructions in lane mode—see below.

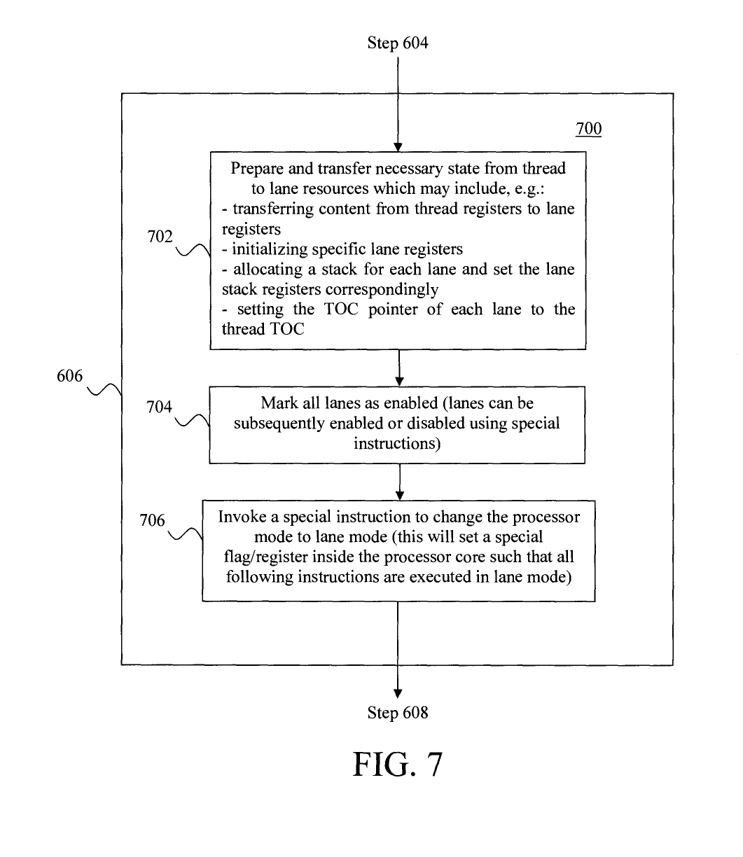

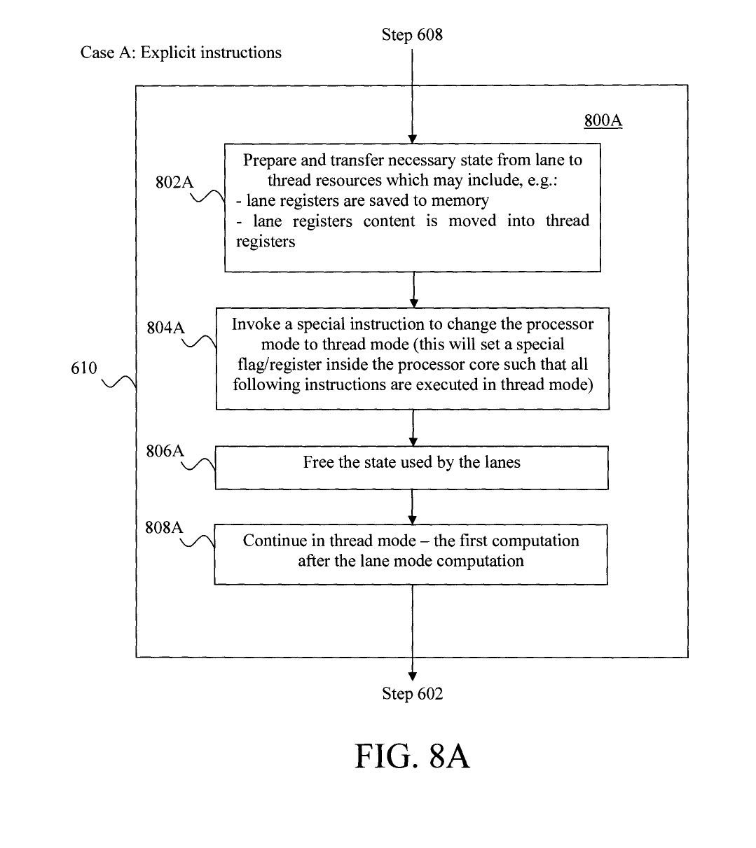

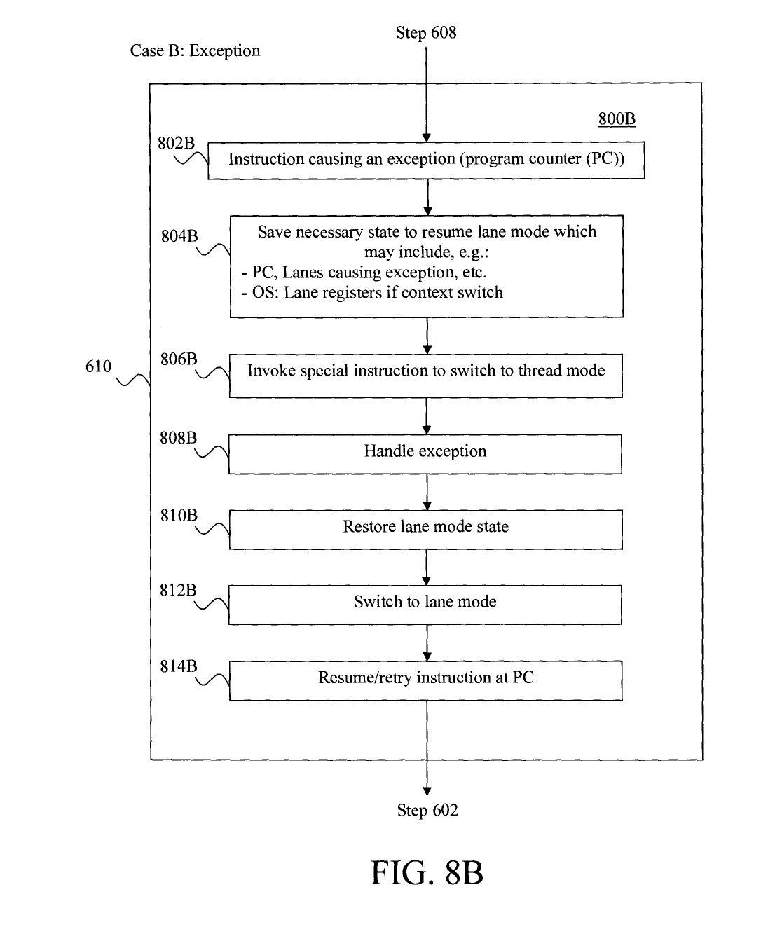

A detailed description of the process of switching the processor core from thread mode to lane mode (as per step 606) is provided in conjunction with the description of FIG. 7, below. A detailed description of the process of switching the processor core from lane mode to thread mode (as per step 610) is provided in conjunction with the description of FIG. 8A (in the case of explicit switching instructions) and FIG. 8B (in the case of an exception), below.

In transitioning the core from thread to lane mode a special instruction can be invoked that will, e.g., set a special flag/register in the processor core such that all subsequent instructions are executed in lane mode. See for example step 706 of FIG. 7, below. Accordingly, once in lane mode, as per step 608, the processor core will perform lane mode computation until either i) an explicit instruction (such as a thread mode request) is encountered in the instruction stream to transition to thread mode or ii) an exception occurs. See also FIGS. 8A and 8B, described below. When either an explicit lane-to-thread instruction or an exception occurs, then as per step 610 the processor core switches execution to thread mode. As shown in FIG. 6, the process is repeated until the computation is finished.

FIG. 7 is a diagram illustrating an exemplary methodology 700 for switching (transitioning) the processor core from thread mode to lane mode. As shown in FIG. 7, methodology 700 represents an exemplary series of steps which may be performed in accordance with step 606 of methodology 600 (of FIG. 6) for switching to lane mode when an explicit instruction is encountered such as a lane mode request.

In step 702, the state of the processor core is transferred from thread mode to lane mode. According to an exemplary embodiment, step 702 involves, but is not limited to, i) transferring content from the thread registers to the lane registers (see above), ii) initializing one or more of the lane registers, iii) allocating a memory stack for each lane and setting the lane stack registers correspondingly, and/or iv) setting the table of contents (TOC) pointer of each lane to the thread TOC (such that the process can continue in lane mode where the thread mode execution ended).

In step 704, all of the (architected) lanes are marked as enabled. It is notable that lanes can be subsequently enabled or disabled using special instructions. A description of enabled/disabled lanes was provided above. Lanes are enabled/disabled to implement control flow divergence. Control flow divergence happens when the instruction stream contains instructions that should not be executed in some of the lanes. Those lanes must then be disabled. At a later point in the execution, control flow reconverges (that is, instructions should again be executed in lanes that were disabled) and disabled lanes are enabled again.

Finally in step 706, a special instruction is invoked to change the processor mode to lane mode. According to an exemplary embodiment, the special instruction sets a special flag/register within the processor core such that all following instructions are executed in lane mode.

It is notable that, in accordance with the present techniques, memory is shared between thread and lane computations. Instructions in lane mode access the same memory address space as instructions in thread mode, and vice versa.

As provided above, the transition of the processor core from lane mode to thread mode can be slightly more complicated. Specifically, when the processor core is operating in lane mode, a switch to thread mode can occur either (voluntarily) in response to an explicit switching instruction such as a thread mode request, or (involuntarily) when an instruction causing an exception occurs (i.e., thus making thread mode a default state). The first case (case A: Explicit instructions) is described in conjunction with the description of methodology 800A FIG. 8A and the second case (case B: Exception) is described in conjunction with the description of methodology 800B of FIG. 8B.

FIG. 8A is a diagram illustrating an exemplary methodology 800A for voluntarily switching (transitioning) the processor core from lane mode to thread mode. As shown in FIG. 8A, methodology 800A represents an exemplary series of steps which may be performed in accordance with step 610 of methodology 600 (of FIG. 6) for switching to thread mode when an explicit instruction is encountered such as a thread mode request.

In step 802A, the state of the processor core is transferred from thread mode to lane mode. According to an exemplary embodiment, step 802A involves, but is not limited to, i) saving the lane registers to memory (see, for example, step 208 of FIG. 2—described above) and/or ii) transferring/moving content from the lane registers to the thread registers (see above).

In step 804A, a special instruction is invoked to change the processor mode to thread mode. According to an exemplary embodiment, the special instruction sets a special flag/register within the processor core such that all following instructions are executed in thread mode. In step 806A, the state used by the lanes is freed, and in step 808A the instruction stream is executed in thread mode. By “state” we mean possible cpu and memory resources (e.g., stack space) that were allocated by the compiler before starting lane mode.

Alternatively, the lane mode can also be interrupted and the core returned to the normal thread mode when an exception occurs during one of the instructions in lane mode. In that case, an exception handler will change the core to thread mode and a return from interrupt will restore the lane mode status. See for example FIG. 8B. As is known in the art, exception handlers are specific subroutines executed to try and resolve an exception. Exception handlers are better executed in thread mode so that they do not have to be concerned with the extra semantics of lane mode.

FIG. 8B is a diagram illustrating an exemplary methodology 800B for involuntarily switching (transitioning) the processor core from lane mode to thread mode. As shown in FIG. 8B, methodology 800B represents an exemplary series of steps which may be performed in accordance with step 610 of methodology 600 (of FIG. 6) for switching to thread mode when an exception occurs during one of the instructions in lane mode. As is known in the art, an exception occurs due to a conflict or error in the instructions, and can cause the operation to halt or abort. Take, for instance, an exception such as a computation involving a division by 0.

In this example, as per step 802B, during execution of the instruction stream in lane mode an instruction occurs causing an exception. A program counter (PC) marks or points to the current instruction (or alternatively the next instruction) being executed. When an exception occurs it is desirable to interrupt the lane mode execution and return the core to the normal (default) thread mode. An attempt will however be made to return to the desired lane mode once the exception has been handled. Thus, in step 804B, the necessary state is saved to subsequently resume lane mode. According to an exemplary embodiment, this includes saving the state of the lanes causing the exception and/or saving the state of the lane registers.

Next, in step 806B, instructions are invoked to switch from lane to thread mode. Once the core is transitioned back into the normal thread mode, the exception can be resolved (i.e., handled). See step 808B. Exceptions can be resolved using an exception handler as known in the art. Once the exception has been resolved, lane mode status can be restored. For instance, in step 810B, the lane mode state is restored and in step 812B the core is transitioned to lane mode. In step 814B, the computation is resumed from where it was left off in step 804B (see above) and the instructions at the lanes causing the exception are retried.

Given the above description of the present thread-to-lane/lane-to-thread mode transitioning techniques, the following is a non-limiting example of how the registers are prepared for a thread to lane mode shift and vice versa:

### Example

Assume user wants to execute the function foo(A, B, . . . ) in lane mode, wherein L is the number of lanes, LGR[0..L][0..32] are general purpose registers for each lane, and GPR[32] are general purpose registers for thread mode. A compiler or the user must wrap the function foo into a single instruction multiple lane execution wrapper that will perform the following actions:

smile_foo(A, B, ...) {

for (i = 0; i<L; i++) { //Transfer necessary state from thread to lanes

| | |
|---|---|
| LGR(i)[6] = N; | // |
| LGR(i)[5] = B; | // prepare parameters for call by copying from thread registers |
| LGR(i)[4] = A; | // to lane registers |

| | |
|---|---|
| LGR(i)[2] = GPR[2]; | // each lane gets the same TOC as in thread mode |

| LGR(i)[1] = stack(i); // each lane gets its own stack | |
|---|---|
| LGR(i)[0] = i; | // each lane gets a lane id (could be a special purpose register (SPR) |

or stack location)

| } | |
|---|---|
| eal | // enable all lanes |

| | |
|---|---|
| switch2lm | // switch to lane mode |

each lane calls foo(A,B)

| | |
|---|---|
| switch2tm | //switch to thread mode |

}

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

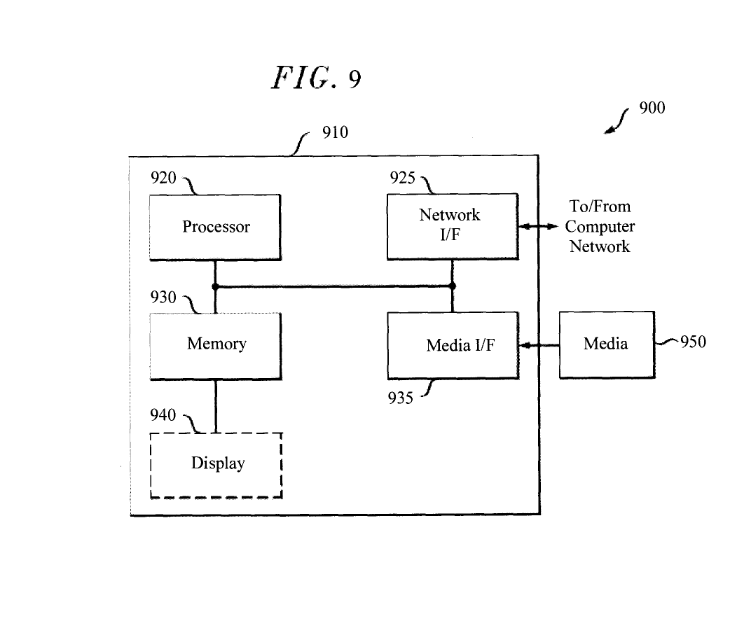

Turning now to FIG. 9, a block diagram is shown of an apparatus 900 for implementing one or more of the methodologies presented herein. By way of example only, apparatus 900 can be configured to implement one or more of the steps of methodology 500 of FIG. 5, one or more of the steps of methodology 600 of FIG. 6, one or more of the steps of methodology 700 of FIG. 7, one or more of the steps of methodology 800A of FIG. 8A and/or one or more of the steps of mythology 800B of FIG. 8B.

Apparatus 900 includes a computer system 910 and removable media 950. Computer system 910 includes a processor device 920, a network interface 925, a memory 930, a media interface 935 and an optional display 940. Network interface 925 allows computer system 910 to connect to a network, while media interface 935 allows computer system 910 to interact with media, such as a hard drive or removable media 950.

Processor device 920 can be configured to implement the methods, steps, and functions disclosed herein. The memory 930 could be distributed or local and the processor device 920 could be distributed or singular. The memory 930 could be implemented as an electrical, magnetic or optical memory, or any combination of these or other types of storage devices. Moreover, the term “memory” should be construed broadly enough to encompass any information able to be read from, or written to, an address in the addressable space accessed by processor device 920. With this definition, information on a network, accessible through network interface 925, is still within memory 930 because the processor device 920 can retrieve the information from the network. It should be noted that each distributed processor that makes up processor device 920 generally contains its own addressable memory space. It should also be noted that some or all of computer system 910 can be incorporated into an application-specific or general-use integrated circuit.

Optional display 940 is any type of display suitable for interacting with a human user of apparatus 900. Generally, display 940 is a computer monitor or other similar display.

Although illustrative embodiments of the present invention have been described herein, it is to be understood that the invention is not limited to those precise embodiments, and that various other changes and modifications may be made by one skilled in the art without departing from the scope of the invention.

1-17. (canceled)

18. A computer program product for executing a single instruction stream having alternating serial regions and parallel regions in a processor, the computer program product comprising a computer readable storage medium having program instructions embodied therewith, the program instructions executable by a computer to cause the computer to:
create a processor architecture having, for each architected thread of the single instruction stream, one set of thread registers, and N sets of lane registers across N lanes;
execute instructions in the serial regions of the single instruction stream in a thread mode against the thread registers;
execute instructions in the parallel regions of the single instruction stream in a lane mode against the lane registers; and
transition execution of the single instruction stream from the thread mode to the lane mode or from the lane mode to the thread mode.

19. The computer program product of claim 18, wherein the instructions in the serial regions of the single instruction stream are being executed in the thread mode against the thread registers, and wherein execution of the single instruction stream is being transitioned from the thread mode to the lane mode, and wherein the program instructions further cause the computer to:
transfer a state of the processor from thread resources to lane resources;
mark all of the N lanes as active; and
invoke a special instruction to change a mode of the processor from thread mode to lane mode.

20. The computer program product of claim 18, wherein the instructions in the parallel regions of the single instruction stream are being executed in the lane mode against the lane registers, and wherein execution of the single instruction stream is being transitioned from the lane mode to the thread mode, and wherein the program instructions further cause the computer to:
transfer a state of the processor from lane resources to thread resources;
invoke a special instruction to change a mode of the processor from lane mode to thread mode; and
free a state used by the N lanes.
